(19) United States
(12) Patent Application Publication
(10) Pub. No.: US 2023/0088950 A1
(43) Pub. Date: Mar. 23, 2023

(54) METHOD AND SYSTEM FOR INTELLIGENT LOAD OPTIMIZATION FOR VEHICLES

(71) Applicant: Braskem S.A., Camaçari (BR)

(72) Inventors: Jaime Tadeu de Paula, Camaçari (BR); Nicholas Fragoso e Silva Ferro, Camaçari (BR)

(73) Assignee: Braskem S.A., Camaçari (BR)

(21) Appl. No.: 17/909,063

(22) PCT Filed: Mar. 6, 2021
(86) PCT No.: PCT/BR2021/050097

§ 371 Date: Sep. 2, 2022

Related U.S. Application Data
(60) Provisional application No. 62/986,318, filed on Mar. 6, 2020.

(51) Int. Cl. G06Q 10/08; G06Q 10/04; G06Q 50/30; G08G 1/00

(52) U.S. Cl. CPC G06Q 10/08355; G06Q 10/047; G06Q 50/30; G08G 1/202

(57) ABSTRACT

It is disclosed a method and system for intelligent load optimization for freight vehicles. The method comprises the step of adjusting, in response to determining a selection of a freight vehicle by a model, a scheduled route associated with the freight vehicle to generate an adjusted route for the 5 freight vehicle, wherein the adjusted route transports the load associated with the customer order and one or more other loads associated with the scheduled route. A method and system for load optimization in a fleet sharing among multiple freight vehicles are also described.

### BACKGROUND OF THE INVENTION

Freight vehicles may be used to transport loads between different locations. While a freight vehicle is delivering a specific load, the freight vehicle may have unused loading capacity. This unused loading capacity may be a waste of resources within an overall freight vehicle fleet.

Freight vehicles are used to transport certain loads between different locations. Daily, several vehicles are responsible for removing a product from a certain point, such as a point A and transporting it to a new location, such as a point B.

The following problems are found in the state of the art regarding the transport of loads: underutilized freight capacity, manual operations (search for a partner, contracting and scheduling, decentralized information, poor real-time tracking, limited access to location, and inaccurate estimated time of arrival, limited visibility on truck availability. In other words, inefficient trucking market offers risks and increases cost for shippers, haulers and customers.

When completing a given route, the same vehicle must then take a new route, thus transporting a new load from a new location to a certain destination.

Thus, a given company can comprise several units of cargo (freight) vehicles that move through a certain location in order to fulfill certain itineraries.

It happens that the management of the routes to be carried out by these freight vehicles is extremely precarious. More specifically, there is no adequate control as to which vehicle must travel a given route in order to reduce costs and increase the efficiency of transport. In addition, there is no adequate management as to which vehicle is the most suitable to pick up a particular product at a location and transport it to the next point.

In some situations, the route management is precariously performed through spreadsheets or even only by phone, in addition, this management is also performed only from the schedule of requests between the shipper and the transport company, so that the company will carry out the requests according to a chronological order, that is, the order received first, will be carried out first, and so on.

In most cases, the route management of cargo (freight) vehicles does not take into account parameters that would aim at a reduction in transport costs as well as greater efficiency in the transport to be carried out.

In an example, it is common for a freight vehicle, when completing a certain itinerary, to return empty (without any load) to a certain point, obviously, this fact is detrimental to the transport company, since the empty vehicle consumes costs that could be reduced if the vehicle were carrying some load.

In addition, it is common for vehicles not to carry their full load capacity, a fact that also generates losses for the transport company.

Another problem found in the state of the art is the lack of cooperation between third parties.

Vehicles from different companies are underutilized when traveling certain routes, wherein in many cases such routes are traveled with the vehicle’s cargo space empty.

In one example, a vehicle from company A has the purpose of traveling to a point X, where such displacement occurs with its empty cargo space. In such displacement, company A's vehicle makes its way close to the sites of company B. It happens that company B has a request to send a material to point X, but said company B does not have any transport vehicle in the nearby and able to make the referred route.

Due to the lack of collaboration between companies A and B, or due to the lack of a collaborative platform between companies A and B, the scenario that occurs in the state of the art consists of the displacement of a transport vehicle from company B to thus collect the material and transport it to point X.

With the present invention, there is a collaboration platform between companies A and B, so that company A's vehicle, having a free load space and moving close to company B's premises, could be selected to carry out a stop at company B and thus transport the material to the desired location.

In this way, there is an optimization in efficiency and reduction in transport costs.

Thus, the present invention proposes a collaborative methodology, system and platform between companies (such as companies A and B), so that a collaborative network can be generated between several companies and whose network allows to make cargo transportation more efficient.

With the present invention, a given company can be prepared to transport a certain product from a partner company, obviously respecting all confidentiality issues involved in transportation.

The present invention proposes a methodology, system and platform that allow employees to view transport vehicles registered on the network, as well as their transport specifications, such as total capacity, refrigerated environment, among several other specificities.

Thus, the present invention suggests to a certain shipper that has the objective to send a product to a certain location, which vehicle, from any of the registered companies, would be able to carry out said transport and with adequate efficiency and reduced costs.

### OBJECTIVES OF THE INVENTION

One objective of the present invention is to propose a method and system for intelligent load optimization for vehicles.

The present invention aims to propose a methodology and system capable of generating a network of logistical transactions between different companies.

It is also an objective of the present invention to propose a methodology and system that allow vehicle sharing among members of the logistics transaction network.

It is also an objective of the present invention to propose a methodology and system that allow the sharing of the cargo transport capacity of vehicles that are part of the logistics transaction network.

An objective of the present invention is to propose a methodology and system that operate through a web platform.

An objective of the present invention is to propose a methodology and system that operate through a mobile application.

An additional objective of the present invention is the proposal of a methodology and system that aim to reduce the displacement of vehicles with underutilized cargo capacity.

The present invention also aims to propose a methodology and system in which each member can form a specific logistical transaction network, so that the logistical network of company A will not necessarily be the same as the logistical network of company B.

It is also an objective of the present invention to propose a methodology and system that are able to generate a displacement map.

The present invention also aims to propose a methodology and system that allows a member of a logistics network to classify certain information as being confidential.

It is also an objective of the present invention to propose a methodology and system that are configured to continuously search for a transport opportunity involving a given logistics network.

It is also an objective of the present invention to propose a methodology and system that are configured to generate an intention to interact between shippers who operate the methodology and system of the present invention.

### BRIEF DESCRIPTION OF THE INVENTION

It is disclosed a method comprising the steps of adjusting, in response to determining a selection of a freight vehicle by a model, a scheduled route associated with the freight vehicle to generate an adjusted route for the freight vehicle, wherein the adjusted route transports the load associated with the customer order and one or more other loads associated with the scheduled route.

It is also disclosed a method for load optimization in a fleet sharing among multiple freight vehicles, the method comprising the steps of: receiving a shipping order from a first shipper, wherein the shipping order has instructions to transport a load associated to the shipping order, continuously search for a transport opportunity involving a logistic network, wherein the first shipper is part of the logistic network, if a transport opportunity is found, the method comprises the step of: receiving an updated shipping order, the updated shipping order comprising instructions to transport a load associated to the updated shipping order.

A system for load optimization in a fleet sharing among multiple freight vehicles is also addressed. The system comprising means to receive a shipping order from a first shipper, wherein the shipping order has instructions to transport a load associated to the shipping order, means to continuously search for a transport opportunity involving a logistic network, wherein the first shipper is part of the logistic network, means to receive an updated shipping order, the updated shipping order comprising instructions to transport a load associated to the updated shipping order.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 shows a system in accordance with one or more embodiments of the technology.

FIG. 2 shows a flowchart in accordance with one or more embodiments of the technology.

FIG. 3 shows an exemplary embodiment of a task index that can be shown to the driver of a freight vehicle.

FIGS. 4.1 and 4.2 show a computing system in accordance with one or more embodiments of the technology.

FIG. 5 shows an exemplary embodiment of a fleet sharing among multiple freight vehicles;

FIG. 6 shows an additional embodiment of a fleet sharing among multiple freight vehicles;

FIG. 7 shows an example of data that can be presented to the user by a user interface;

FIG. 8 shows a block diagram regarding the fleet sharing feature proposed in present invention.

### DETAILED DESCRIPTION

Specific embodiments of the technology will now be described in detail with reference to the accompanying figures. Like elements in the various figures are denoted by like reference numerals for consistency.

In the following detailed description of embodiments of the technology, numerous specific details are set forth in order to provide a more thorough understanding of the technology. However, it will be apparent to one of ordinary skill in the art that the technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments are directed to a system and method for managing load capacity of a freight vehicle fleet using a model for adding and/or removing loads from scheduled routes. For example, a load may be matched to a particular freight vehicle according to various cost parameters and/or freight vehicle parameters. In particular, load matching may be performed in order to reduce the amount of unused loading capacity within a freight vehicle fleet. In this sense, load matching may be used in order to achieve maximum loading capacity of the freight vehicle, wherein by maximum loading capacity one should understand as an optimum use of the freight vehicle, meaning not necessarily the full capacity of every use of the freight vehicle. Likewise, load matching may also be used to reduce various costs incurred by the freight vehicle fleet, such as reducing total distance being driven by respective vehicles, reducing the amount of overtime driving by vehicle human operators, reducing the amount of time between picking up a load and the delivery of the load, etc. Accordingly, in some embodiments, a model is used to adjust or generate scheduled routes for freight vehicles within one or more freight vehicle fleets to perform such load matching.

By freight vehicle, one should understand as any vehicle which is able to transport any kind of load.

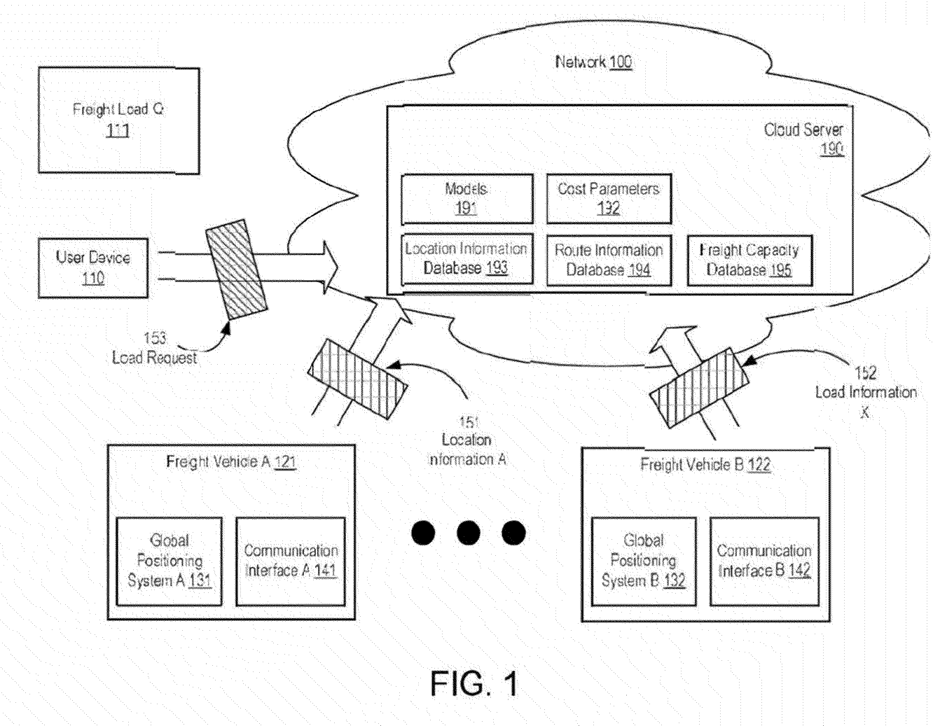

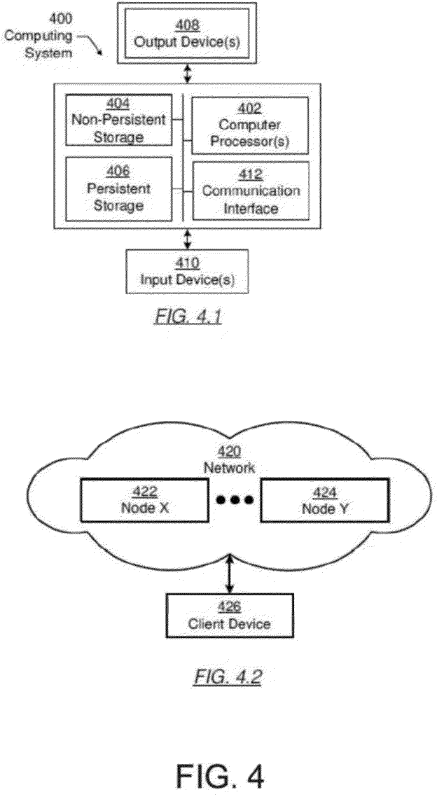

Turning to FIG. 1, FIG. 1 illustrates a cloud server (190) that communicates with various freight vehicles (e.g., freight vehicle A (121), freight vehicle B (122)) over a network (100). For example, a freight vehicle may be an automobile that is equipped with a computer system similar to a computer system (400) described below in FIGS. 4.1 and 4.2 and the accompanying description. The network may be a cellular network, a satellite communication network, a public Wi-Fi network, etc. As shown, the cloud server (190) may collect location information (e.g., location information A (151)) regarding the freight vehicles (121, 122). For example, the location information may be stored in a location information database (193). The location information may include real-time global position system (GPS) coordinates regarding the freight vehicles within a predetermined geographic area. For example, the freight vehicles (121, 122) may include respective GPS devices (e.g., GPS A (131), GPS B (132)) that acquires the location of the respective freight vehicle. Likewise, the freight vehicles (121, 122) may include communication hardware/software for communicating with the cloud server (190) over the network (100) in real-time. For example, the communication hardware may include antennas, cellular transceivers, satellite modems, communication interfaces (e.g., communication interface A (141), communication interface B (142)) and/or other hardware for transmitting information to and from the cloud server (190).

In some embodiments, the freight vehicles (121, 122) are part of a freight vehicle fleet managed by the cloud server (190). For example, the cloud server (190) may manage single pick-up and delivery points for multiple scheduled routes performed by freight vehicles. In some embodiments, the cloud server (190) may manage a ‘dedicated fleet’, while in some embodiments, the cloud server (190) may manage multiple freight vehicle fleets controlled by multiple parties. Likewise, the cloud server (190) may also communicate with other cloud servers that manage their own fleets.

The cloud server (190) may also collect load information (e.g., load information X (152)) regarding the freight vehicles and store the load information in a freight capacity database (195). For example, load information may describe the amount of load capacity currently being use or may be used in the future by a freight vehicle. After a freight vehicle A (121) obtains an initial delivery, freight vehicle A’s capacity may be at 25% of its cargo space. Based on scheduled pick-ups through a particular day, the load capacity of freight vehicle A (121) may be expected to peak at 80% of full capacity before dropping due to making deliveries. Accordingly, the cloud server (190) may aggregate data regarding past, current, and future cargo loads, e.g., to optimize freight vehicle utilization.

Furthermore, the cloud server (190) may also collect route information regarding the freight vehicles (121, 122) and store the route information in a route information database (194). For example, a freight vehicle may have a scheduled route where one or more loads are acquired and where the one or more loads are delivered to a particular destination. For example, a scheduled route may be static route describing specific itinerary between multiple destination points. Likewise, a scheduled route may also be a dynamic route that is adjusted throughout traveling of the route by an operator or automatically based on a routing program, e.g., in response to traffic, a request to deliver a new load, updates to road conditions such as a wreck, etc. The scheduled route may also be updated due a new order that comprises instructions to update the route. A scheduled route may be generated and/or adjusted by a mapping algorithm performed by the freight vehicle (e.g., using a mapping device with a GPS), by the cloud server (190), or by a third party server.

Such mapping algorithm would run on the cloud server and even by the vehicle itself through a device/ embedded system/application. Any Global Navigation System could be used, like GPS or any other navigation system available in the art. The GPS specific capability can be used to help generate/visualize such new route. However, GPS device won’t run the algorithm itself (calculations). GPS serves as source of location information (coordinates), then the algorithm runs (in other application than the GPS) and then GPS device receives results of the calculation and show the new route.

In some embodiments, a user device (110) may transmit a request (i.e., load request (153) to the cloud server (190) to deliver a load (i.e., freight load Q (111)) using a freight vehicle fleet (e.g., the freight vehicles (121, 122)). As such, once the cloud server (190) receives the request (153), the cloud server (190) may use one or more models (191) with respect to various cost parameters (192) and vehicle parameters in order to determine which freight vehicle (121, 122) collects the freight load Q (111). Likewise, the cloud server (190) may adjust one or more scheduled routes to deliver the freight load Q (111) to a destination associated with the load request (153).

In some embodiments, the cloud server (190) performs a local optimization algorithm, such as a Greedy algorithm, to manage load capacity in a freight vehicle fleet. For example, a local optimization algorithm may use location information, origin/destination information of a load, type of load, type of freight vehicle, layout of the load in the freight vehicle, temperature control in the freight vehicle, a freight vehicle position along a scheduled route, empty miles where the freight vehicle is not at full load capacity (e.g., actual miles of a particular freight vehicle on one or more scheduled routes and or historical miles of other freight vehicles), freight vehicle historical speed (estimated constant), loading/unloading time of a freight vehicle at a load origin or load destination, and/or transportation bids between different fleets. In some embodiments, for example, a model is based on ‘clusters’ of locations. Likewise, an optimization algorithm may be performed for a single day transport (i.e., a load is picked up and delivered on the same day) and/or multi-day transports (i.e., one or more loads are picked up and delivered over multiple days). In some embodiments, a ‘global’ optimization algorithm is performed by the cloud server (190). An optimization algorithm may be performed iteratively using different cost parameters and/or vehicle parameters in order to determine a lowest overall transportation cost, e.g., the best selection of a freight vehicle within a dedicated fleet to transport a particular load over a scheduled route. Present invention is beneficial in planning future routes. Present invention runs different scenarios in order to find the lowest overall transportation cost, indicating for each load the contract model and in case of dedicated fleet the right truck.

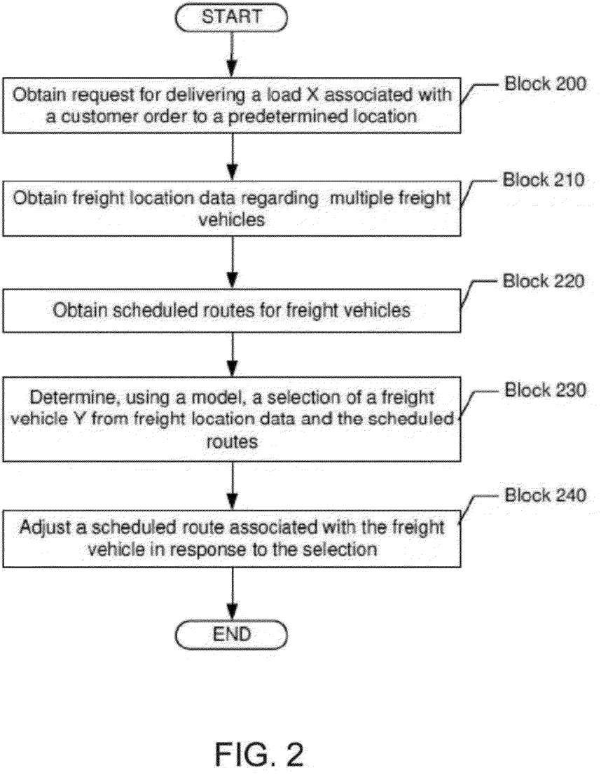

In some embodiments, the cloud server (190) generates and/or updates models using real time information regarding freight vehicles, load requests, location information, and/or load information to decide the best case scenario for freight vehicle fleet utilization. For example, a model may be updated using machine-learning or artificial intelligence techniques. Likewise, a training data set may be acquired from historical routes and load deliveries to predict future optimized routes and freight vehicle fleet management. For more information on models and cost parameters, see Block 230 in FIG. 2 and the accompanying description below.

In some embodiments, the cloud server (190) may be a digital platform for freight management, or optimization of freight cost and fleet productivity. For example, the cloud server (190) may provide a single interface to user devices regarding real-time information on freight demand and freight capacity, vehicle position and status (empty/full), vehicle routes and maps, business rules and other parameters for managing freight capacity. Further, the invention considers information regarding sales order, client, product, origin, weight and delivery date. Any of said parameters may be included in an order, such as a shipping order. The cloud server (190) may automatically perform an analysis of various parameters in order to instantly match freight vehicles and freight loads, automatically schedules load shipments, and then monitor the delivery from pickup to drop-off. The cloud server (190) may further provide status updates and estimated time to arrival of various load shipments. In some embodiments, the cloud server (190) may use historical shipments and fleet performance data and predictive analytics to calculate and present best cost and performance scenarios for transporting loads over a geographic area.

In some embodiments, the cloud server (190) provides standardization and automation of various transportation processes leading to less error, less back and forth communication, reduced time in responding to requests, and reduced operational costs. For example, present invention may increase fleet performance and revenue for carriers and fleet owners, increased availability of freight service and reduced freight cost for shippers, increase transparency and visibility in various steps of the transportation process. The cloud server (190) may also provide financial information and operational key performance indicators in order to analyze shipping operations. In some embodiments, the cloud server (190) provides analytics for data-driven decision processing. Likewise, the cloud server (190) may provide a single platform that aggregates functionality for a load shipper or carrier, e.g., with respect to freight management, standardization, and automation of various processes, such as real-time tracking to intelligent pricing and instant quote/bidding.

In some embodiments, the cloud server (190) provides end-to-end optimization based on time and cost parameters. Likewise, the cloud server (190) may provide instant quotes regarding the price of shipping, the estimated time to perform a transport of a load, and smart contracting.

In some embodiments, the cloud server (190) generates a map within a graphical user interface on a user device regarding deliveries and/or freight vehicles within a geographic region of interest. For example, the map may illustrate freight vehicle availability status and estimated time of arrivals. Likewise, the cloud server (190) may obtain a user selection regarding a freight vehicle for a freight load with a ‘drag and drop’ feature. The graphical user interface may include a dynamic savings calculator, an automatic load match feature for long haul, and for short haul, various travel routes options with corresponding distances, fleet view dashboard and scheduling view. The user interface may also include pickup and drop down windows, delivery steps describing a load delivery or scheduled route, load status updates, freight vehicle status updates, various options for fleet sharing, alerts and notifications, etc. In some embodiments, the cloud server (190) may implement a user interface with multiple user devices. For example, a user device may visualize and provide interaction functionality for users with respect to various load matching and/or fleet sharing features. In particular, the cloud server (190) may provide real-time tracking and recommendations of freight vehicles that may be illustrated in a user device. Likewise, the user interface may provide recommendations based on one or more algorithms as well as updates on adjusted routes based on the one or more algorithms. In some embodiments, users may adjust parameters for their desired loads and/or schedule routes within the user interface, and the cloud server (190) may then present updated information based on the adjusted parameters accordingly.

In some embodiments, the cloud server (190) performs one or more algorithms to implement fleet sharing among multiple freight vehicles. For example, different shippers and companies may match loads to a shared space in a freight vehicle. As such, a freight vehicle may be a common freight vehicle that provides load transportation for multiple parties managed by the cloud server. These different parties may send requests through an interface to the cloud server (190) regarding their own loads, such that depending on various parameters, such as loading locations, delivery locations, the schedule route of the common freight vehicle, type of load, type of freight vehicle, layout of the load in the freight vehicle, etc., the cloud server (190) may assign multiple loads from the different parties to the common freight vehicle. Accordingly, which loads are assigned to the shared space may be optimized in addition to the route used to transport the different loads. As such, various algorithms used for load matching may also be tailored for fleeting sharing. Thus, a fleet sharing system may go beyond load matching to coordinate dynamically between compatible types of loads that may share a freight vehicle, matching routes before determining which loads from different partners will share the freight vehicle. In some embodiments, similar to load matching, scheduled routes may be adjusted to optimize fleeting sharing within a network.

While FIG. 1 shows various configurations of components, other configurations may be used without departing from the scope of the disclosure. For example, various components in FIG. 1 may be combined to create a single component. As another example, the functionality performed by a single component may be performed by two or more components.

Embodiments described above with respect to FIG. 1 are designed to provide a platform that matches loads and trucks, connecting shippers and freight businesses and creating efficiency, transparency, and trust by utilizing intelligent load matching (capacity matching, fleet sharing, freight bundling), reliable and real-time tracking of loads and ETA, end-to-end route optimization based on time and cost, provides instant price and quotes and allows for smart contracting operations. Said platform may be used by multiple shippers in a fleet sharing among multiple freight vehicles.

Turning to FIG. 2, FIG. 2 shows a flowchart in accordance with one or more embodiments. Specifically, FIG. 2 describes a method for selecting freight vehicles for load management. While the various blocks in FIG. 2 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 200, a request is obtained for delivering a load X associated with a customer order to a predetermined location in accordance with one or more embodiments.

In Block 210, freight location data is obtained regarding multiple freight vehicles in accordance with one or more embodiments.

In Block 220, scheduled routes are obtained for freight vehicles in accordance with one or more embodiments.

In Block 230, a selection of a freight vehicle Y from freight location data and scheduled routes using a model in accordance with one or more embodiments.

In some embodiments, the model may determine a set of scheduled routes, loading times, and delivery times, such that various parameters may be respected or respected within a predetermined degree of tolerance. For example, the model may determine or adjust a scheduled route that begins and ends at the same loading station. In another example, the model may determine or adjust a scheduled route according to various route duration limits, e.g., if a freight vehicle is identified as being only able to travel a specific number of miles per day, the model may not determine a scheduled route where the cumulative pick-ups and deliveries exceeds this number of miles.

In some embodiments, a model satisfies determines and/or adjusts scheduled routes. For example, the cost function may include various cost parameters as an overtime pay of a vehicle operator, a duration cost of changing a scheduled route, or a bid cost of an entity requesting one or more load deliveries.

In some embodiments, a cloud server may use artificial intelligence or machine learning to determine an optimized route for a load delivery. For example, a cloud server may perform simulations regarding different scheduled routes or possible routes of one or more freight vehicles. Likewise, a cloud server may use one or more trained models based on historical location information, historical route information, historical cost information, and/or historical capacity information to generate and/or update the one or more models. For example, different types of models may be trained, such as convolutional neural networks, deep neural networks, support vector machines, decision trees, inductive learning models, deductive learning models, supervised learning models, etc. Likewise, the model may determine one or more local optimums or one or more global optimums in generating and/or adjusting scheduled routes for delivering loads.

In Block 240, a scheduled route associated with a freight vehicle Y is adjusted in response to determining a selection of the freight vehicle Y in accordance with one or more embodiments. For example, a particular load may be added to a freight vehicle that already has a scheduled route for a different load. Likewise, a predetermined freight vehicle may be removed from one scheduled route to handle a new load, while a different set of freight vehicles have their scheduled routes adjusted in order to meeting the previous load requests of the predetermined freight vehicle.

In some embodiments, a method may obtain a request for delivering a first load associated with a customer order to a predetermined location. The method may further obtain, from a plurality of freight vehicles, freight location data regarding the plurality of freight vehicles. The method may further obtain a plurality of scheduled routes that the plurality of freight vehicles are following, wherein at least one route among the plurality of scheduled routes corresponds to a travel itinerary from a loading location to an unloading location. The method may further determine, from the freight location data and the plurality of scheduled routes, a selection of a first freight vehicle among the plurality of freight vehicles using a model, wherein the model identifies the first freight vehicle having a first transport capacity for carrying the first load. The method may further adjust, in response to determining the selection of the first freight vehicle, a scheduled route associated with the first freight vehicle to generate a first adjusted route for the first freight vehicle, wherein the first adjusted route transports the first load associated with the customer order and one or more loads associated with the scheduled route.

In some embodiments, a method may obtain, using a global positioning system (GPS) device on a second freight vehicle, GPS coordinates of the second freight vehicle. The method may transmit, by a communication interface on the second freight vehicle, the GPS coordinates to a remote server or a cloud server. In some embodiments, GPS devices are included in every freight vehicle in a freight vehicle fleet.

In some embodiments, a method simulates, using a model, a transportation of a first load associated with a customer order using a plurality of scheduled routes to produce a plurality of simulations. The method may further determine, based on the plurality of simulations, a respective cost for transporting the first load using a plurality of adjusted routes to determine a plurality of costs, wherein the first freight vehicle is selected using the plurality of costs. The plurality of costs may be determined using at least one of the following vehicle parameters: current vehicle information, such as semi-trailer type and number of axes, current vehicle position, current estimated time of arrival along a respective scheduled route, and a current transport capacity. Any other parameter could be used. The plurality of costs may be determined using at least one of the following customer order parameters: a total weight and volume of the first load, a delivery date of the first load, a starting location for obtaining the first load, time window for obtaining the first load, a destination location for delivering the first load, time window for delivering the first load and order constraints, such as origin and destination constraints. The plurality of costs are determined using at least one of the following route parameters: a loading time along the respective scheduled route, an unloading time along the respective scheduled route, a route duration, and a number of empty miles along the respective scheduled route.

In some embodiments, a method may simulate, using a model, a transportation of the first load associated with the customer order using the plurality of scheduled routes to produce a plurality of simulations. The method may determine, based on the plurality of simulations, a respective travel time for transporting the first load using a plurality of adjusted routes to determine a plurality of travel times, wherein the first freight vehicle is selected using the plurality of travel times.

In some embodiments, a method may determine whether a remaining transport capacity for a second freight vehicle is greater than a second load scheduled for transportation by the second freight vehicle. The method may also transmit, automatically in response to determining that the remaining transport capacity is greater than the second load, a command to cause the transport load to be delivered using the second freight vehicle. The method may also determine a second adjusted route for the second freight vehicle, the second adjusted route having a starting location and an ending location, wherein the second load is disposed in the second freight vehicle at a predetermined time prior to the second freight vehicle initiating travel along the second adjusted route.

In some embodiments, a model may be generated using an artificial intelligence algorithm based on vehicle parameter data, customer order parameter data, and route parameter data, and wherein the artificial intelligence algorithm is selected from a group consisting at least from: a decision tree algorithm, a support vector machine, an ensemble method, and a naive Bayes classifier algorithm. Any other method / algorithm that is able to absorb the teachings of the present invention could be used.

In one embodiment, the algorithm map decision variables (trucks available, contracting model, number of orders, or any other parameter, and define an objective function or functions and define the set of constraints (limitations/requirements) and a determined time window.

As addressed before, present invention may implement a fleet sharing among multiple freight vehicles. Briefly, fleet sharing (or freight sharing) occurs when a shipper has a fleet of vehicles at his disposal and is looking for ways to increase fleet productivity by offering empty space to other shippers. To assess the possibility of sharing, it is necessary for shippers to have common routes, and to use the types of trucks allowed in each operation.

A method and system for load optimization in a fleet sharing among multiple freight vehicles is addressed.

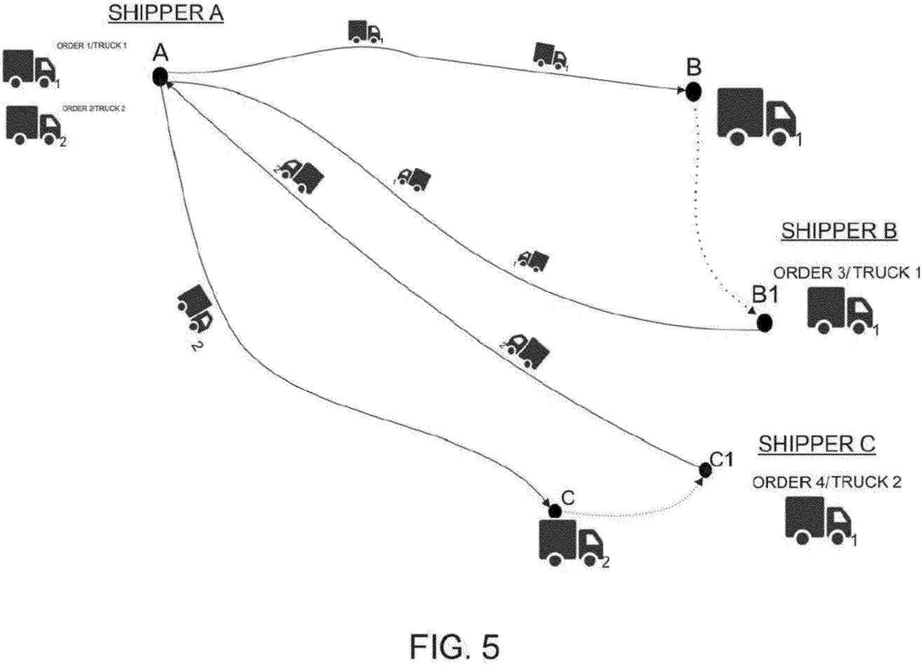

FIG. 5 is an exemplary illustration of a way of operating the teachings of the present invention in a fleet sharing among multiple freight vehicles, addressing a collaborative participation between senders (shippers). In this figure, shipper A has a shipping order (order 1) for transporting a load between point A and point B, thus returning later to point A. Thus, shipping order comprises an instruction data for shipping the product from point A to point B and also comprising instruction data to return to point A.

In one scenario, once the product has been transported to point B, it has to be said that, during the return journey from point B to point A, or at a point still close to point B, an updated shipping order is received by truck 1 (order 3) instructing the vehicle to move to point B1 and thus carry out a new loading in B1, so that the updated shipping order includes instructions for the transport of the product from point B1 to point A.

It is thus observed that the original shipping order (order 1) comprises an instruction in common with the updated shipping order (order 3), an instruction in common in this case that refers to the return of truck 1 to point A.

Thus, and still referring to FIG. 5, it is shown the displacement of truck 1 with a load represented by solid lines, so that the displacement between B and B1 is indicated by dashed lines, thus representing that, only during this path, truck 1 would have its cargo space empty.

Still referring to FIG. 5, there is the same representation for an additional truck from shipper A, wherein the truck is referred to as truck 2. By truck, one should understand as a freight vehicle or a vehicle that is able to carry a load.

Thus, truck 2 comprises a shipping order (order 2) with an instruction data to transport a product from point A to point C and later return to point A. Thus, upon completing the shipment to point C or at a point close to C during its journey (going to C or coming from C), an updated shipping order (order 4) is received by the truck 2 and comprising an instruction data so that it should move to point C1, for a new loading, and later return to point A.

In this sense, the updated shipping order (order 4) comprises a data (information) in common with the original order (order 2), in this case indicating the return to point A.

There is thus a collaborative transport between shippers A, B and C, preventing truck 1 from returning empty from point B to point A and also preventing truck 2 from returning empty from point C to point A.

Thus, in the representation illustrated in FIG. 5, there is the scenario in which the trucks move with one load and return with another load, thus avoiding the return of the freight vehicles with their empty cargo spaces.

It should be noted that the representation of FIG. 5 indicating only trucks 1 and 2 should not be considered as a limiting feature of the present invention, so that the teachings herewith proposed could be absorbed for any number of vehicles, such as an N number of transport vehicles (freight vehicles).

Furthermore, the illustration of only three senders (shippers) A, B and C should also not be considered as a limiting feature, so the invention is able to use any desired number of senders who wish to be part of the collaborative platform proposed in the present invention.

In one modality, and after delivering the product at point B, the updated shipping order (order 3) could be rejected by truck 1 or even automatically rejected by the methodology / system proposed in the present invention, in case, for example, said truck 1 were at a greater distance from point B than a predetermined distance, in this case, it would not be plausible, in terms of cost, to go back to point B1 to perform the new load pick up.

It should be emphasized that the teachings of the present invention can be applied both to the concept of FTL (full truck load) and to the concept of LTL (less than truck load).

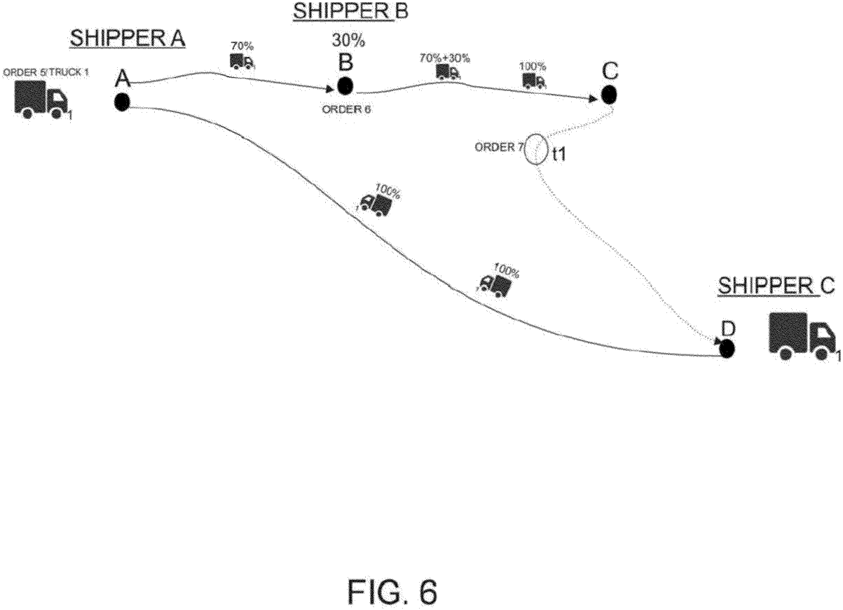

Thus, in a new representation illustrated in FIG. 6, there is the displacement of truck 1 from sender A (point A) to point C, wherein said displacement occurs based on a shipping order (order 5) that includes data for transporting the product from A to end point C.

In this case, it should be noted that the shipping order includes instructions for transporting the product from A to C.

During the route from A to C, there is an updated shipping order (order 6) for transporting a product from B to C, so there is a stop at point B to pick up the load to be sent to point C.

In this case, it is proposed that a step of checking the total load capacity of truck 1 to be evaluated, more specifically, the displacement from A to B can occur, for example, with 70% load capacity and the displacement from B to C can complete the full load capacity of the truck, that is, reaching 100%. It is understood that in B the truck was loaded with 30% of its load. In addition, the product that represents 70% of the truck’s load may be a different product than the one that represents 30% of its load.

It is understood, therefore, that the teachings of the present invention allow the same truck to transport different products (different loads), provided, obviously, such products can be transported together and without any type of risk.

Thus, in the scenario where the vehicle is transported with a lower load capacity (lower than 100%), an updated shipping order may comprise instructions for changing, in this case, increasing the shipping capacity through a new stop at a location. Thus, the updated shipping order (order 6) of FIG. 6 completed the truck’s loading capacity (100%) and still comprised an instruction in common with the original order (order 5), so that said instruction in common refers to instruction to travel to point C. By load capacity, it is understood as the amount of load that is transported in the truck. So that a load capacity of 0% indicates that the truck is empty and a capacity of 100% indicates that the truck is full.

In FIG. 6, having unloaded the truck at point C, a new updated shipping order (order 7) can be received for a stop at an additional point D and thus return to point A. FIG. 6 illustrates the instant t1 in which order 7 was received by the truck, thus comprising an instruction data for displacement to point D to pick up a load and then return to point A.

With the proposed methodology, the truck is prevented from returning to point A with its load capacity zeroed.

Also, in FIG. 6, the dashed line indicates the displacement of truck 1 completely empty.

Thus, the combination of the examples shown in FIGS. 5 and 6 is fully acceptable.

In one embodiment, the teachings of the present invention propose the generation of a displacement map between those involved in a logistic transport network (logistic network). For example, and taking FIG. 6 as a reference, the displacement map could be displayed on the screen of an electronic device and inform senders A and B the route taken by truck 1 between points A and C.

Similarly, the displacement map could be displayed to senders (shippers) A and C on the route taken by the truck between points D and A.

Furthermore, it is reinforced that the teachings of the present invention can be applied to any number of freight vehicles, yet, it can be applied only the concept of FTL and LTL as well as the combination of these. Furthermore, the teachings of the present invention can be applied to any number of shippers.

Additionally, the system proposed in the present invention acts as an intermediary between several senders, thus not providing information that can be classified as confidential. In a non-limiting example, the value of the load in transport can be considered as a confidential information. Thus, the methodology proposed in the present invention also comprises the step of classifying at least one information as a confidential information, so that, by confidential information, it is understood as information that cannot be viewed by at least one from the sender and the recipient of the load.

Furthermore, and based on the teachings of the present invention, each shipper can establish its specific network of contacts, for example, and based on FIG. 5, shipper A has its network formed by shippers B and C. On the other hand, the logistic network of shipper B is solely formed by shipper A, the same occurring for shipper C, which relates only to shipper A. It is understood that a logistic network of a first shipper may not be the same logistic network of a second shipper.

Thus, the present invention allows each shipper to choose which partner will be chosen for a given logistics transaction. In addition, a given shipper may have its network formed by several partners or formed by only one partner, and this feature should not be considered as a limitation of the present invention.

Furthermore, it is proposed that the number of trucks for each shipper should also not be considered as a limiting feature of the present invention, so that, in a valid modality, each shipper can assign the desired number of vehicles that he wishes to integrate the fleet sharing concept.

Thus, when a network of contacts is formed, such as the network between A, B and C illustrated in FIG. 5, the teachings of the present invention propose that the system will continually search for a transport opportunity that involves said network. Once this transport opportunity has been found, it must be informed to the shippers involved, who will have the possibility to accept or refuse it. In one embodiment, and once a transport opportunity is found, an alert may be issued to the shippers involved in the transport opportunity. Said alert may be issued in an electronic device of the shippers involved.

It is proposed that the transport opportunity should be displayed on a screen of an electronic device that can be accessed by the shippers involved.

In one further embodiment, it is proposed that a particular shipper can generate an intention to interact with an additional shipper. For example, a shipper X (referred as a particular shipper) can generate an intention to interact with a shipper Y (referred as an additional shipper). In this way, it is proposed that this intention to interact to be configured as a digital message to be sent from shipper X to shipper Y. Thus, upon receiving said intention, shipper Y should assess whether it would like to include shipper X in its logistic network.

In a non-limiting mode, said intention to interact should be viewed on the screen of an electronic device that is operated by shipper Y.

Thus, the present invention allows a particular shipper to increase its transport contact network (logistics network), thus reducing the costs associated with moving the empty truck.

Present invention further allows the generation of simulations that can be used for analysis, predictions, planning (such as scale up number of vehicles in the fleet or redistribute fleet among regions to maximize utilization), and in this case not necessarily actually performing adjusts of assigning loads to trucks (loads and trucks in such simulations could be existent or made-up for the sake of studying scenarios).

The teachings of present invention may be used for back haul or partial load (LTL). By back haul, one should understand that the truck rides from point A to B full but the return (B to A) is empty. By partial load or LTL, one should understand that the truck rides from point A to B with idle space.

Further, the following variables may be considered according to the teachings of present invention:
Available empty space;
Type of truck available and requirements (curtain side, side wall open, box...);
Products allowed and companies (the shipper must determine which product or companies are allowed for fleet sharing);
Cost of available space (fixed cost, variable cost, overtime cost);
Route Information (origin, destination, estimated displacement time)
Load (origin) and Unload (destination) date;
Expected date of return;
Product and quantity available to deliver;
Maximum number of hours that the driver can drive per day and number of hours already driven that day;
Overnight costs (when the driver needs to sleep at a site to pick up the load)

Any other variable (parameter) mentioned in present application may be used in the system and methodology herewith proposed.

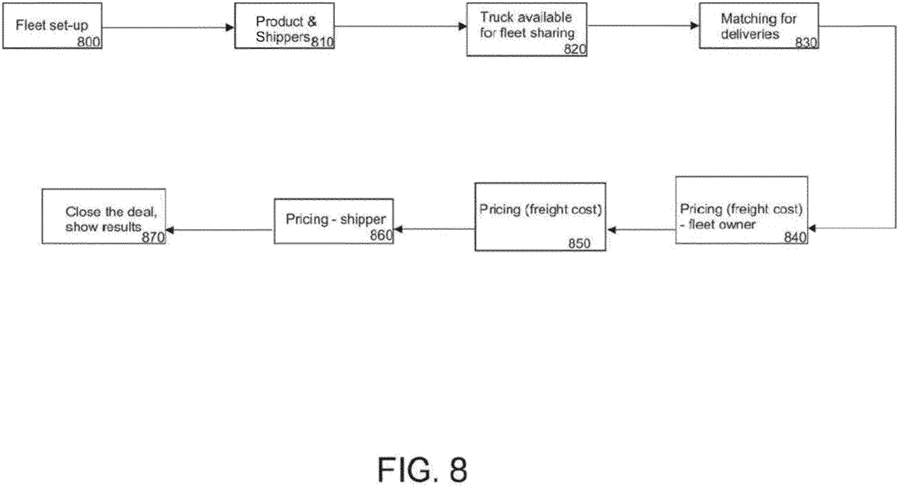

FIG. 8 illustrates a block diagram regarding the fleet sharing feature proposed in present invention.

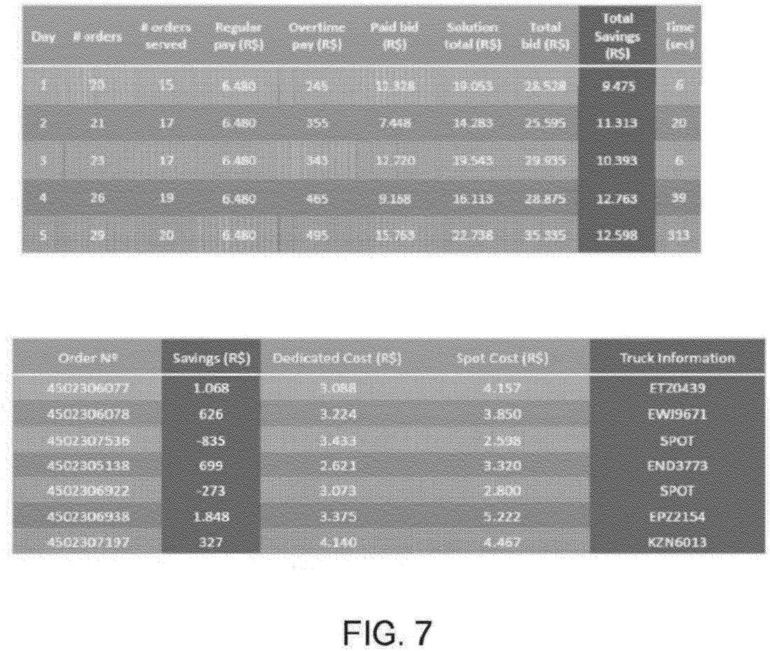

In block 800, a fleet owner may input the fleet set-up, for example, the truck (s) information, such as type of truck (s), maximum load, year, number of axis, freight rate calculation. Each truck may have a truck ID (truck information), as indicated also in FIG. 7.

In block 810 (product and shippers), it may define products that are allowed to load and possible shippers that are allowed to “see” the available space.

In block 820 (truck available for fleet sharing), it should be informed, for example, the type of fleet sharing (back haul, partial load), route (origin and destination), date of loading and date of delivery. At this step, the user may classify any information as a confidential information.

In block 830 (matching for deliveries), a transport opportunity is search, that is, the system looks for shippers that fulfill all the truck minimum requirements. In other words, the matching algorithm ingests all the truck related data and available deliveries. As a result, the solution can present a list of available orders and estimated rentability.

In block 840, the system may present the matching details and calculated freight cost to fleet owner. In block 850, the fleet owner may approve, change the values or decline. If fleet owner declines do not go to next step.

In block 860 (pricing-shipper), it should be presented the final freight price to available shipper, if shipper accepts goes to next step.

In block 870, the result is shown to fleet owner and shipper, match details, freight price, operation deadlines.

Embodiments may be implemented on a computing system. Any combination of mobile, desktop, server, router, switch, embedded device, or other types of hardware may be used. For example, as shown in FIG. 4.1, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (400) in FIG. 4.1 may be connected to or be a part of a network. For example, as shown in FIG. 4.2, the network (420) may include multiple nodes (e.g., node X (422), node Y (424)). Each node may correspond to a computing system, such as the computing system shown in FIG. 4.1, or a group of nodes combined may correspond to the computing system shown in FIG. 4.1. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (400) may be located at a remote location and connected to the other elements over a network.

Although not shown in FIG. 4.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 4.1. Further, the client device (426) may include and/or perform all or a portion of one or more embodiments of the disclosure.

The computing system or group of computing systems described in FIGS. 4.1 and 4.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these interprocess communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user’s selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user’s selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (400) in FIG. 4.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 4.1, while performing one or more embodiments of the disclosure, may perform data comparison. Data comparison may be used to compare two or more data values (e.g., A, B). For example, one or more embodiments may determine whether A > B, A = B, A != B, A < B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A > B, B may be subtracted from A (i.e., A - B), and the status flags may be read to determine if the result is positive (i.e., if A > B, then A -B > 0). In one or more embodiments, B may be considered a threshold, and A is deemed to satisfy the threshold if A = B or if A > B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 4.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 4.1 may include functionality to present raw and/or processed data, such as results of comparisons and other processing. For example, presenting data may be accomplished through various presenting methods. Specifically, data may be presented through a user interface provided by a computing device. An example of data presented through a user interface is shown in FIG. 7. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 4.1 and the nodes and/or client device in FIG. 4.2. Other functions may be performed using one or more embodiments of the disclosure.

While the technology has been described with respect to a limited number of embodiments, those skilled in the art, having benefit of this disclosure, will appreciate that other embodiments can be devised which do not depart from the scope of the technology as disclosed herein. Accordingly, the scope of the technology should be limited only by the attached claims.

The teachings of present invention allows for many benefits. For freight businesses, it allows an increased utilization rate and analytics-oriented decision making. For shippers, allows increased freight availability, best cost x benefit model and central information. For end users and customers, allows visibility of the entire process and precise location and ETA.

Further, present invention centralizes info of demand, truck position and status, routes and maps, client constraints, business rules and uses predictive analytics and algorithms to find the best contracting model and the best freight vehicle to each job. Present invention further allocates loads, creates transportation orders, schedules carrier service and monitors what happens step-by-step from pickup to delivery.

Present invention may also be used in combination with ERP softwares (and/or with Transportation Management Systems (TMS) and other proprietary or third party systems/softwares that are in use by the parties), defining the number of trucks necessary to deliver all orders with the maximum truck weight and value.

Present invention allows to reduce total freight cost while ensuring that all orders are delivered at the required date. Further, some of the parameters considered are the following: industrial unit locations, origin/destination of loads, truck position, empty miles, route duration, loading/unloading time, type of truck allowed for each industrial unit, client and next pick up location, departure time allowed for each truck, regular hours and overtime and time window for industrial units. The teachings of present invention further allows for optimization in the planning for future routes (D+1...D+N).

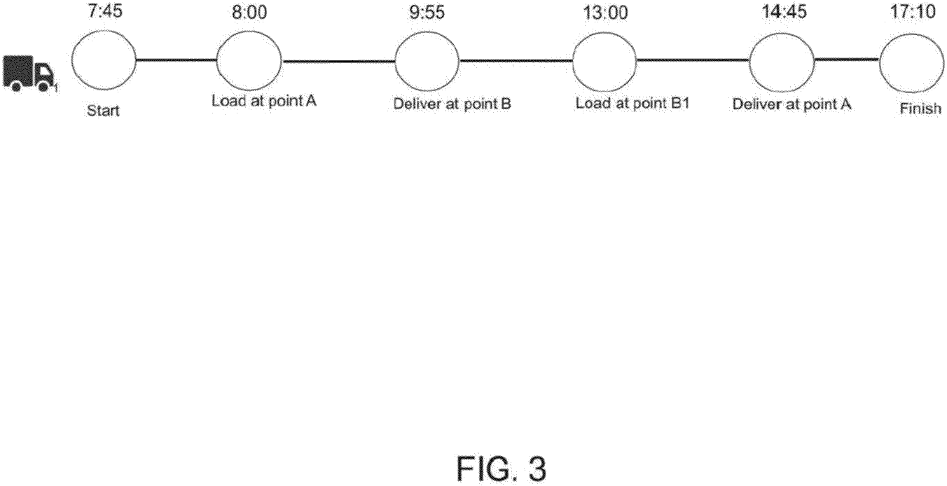

Further, present invention allows the driver of the truck to known what he needs to do in each given day, when and where each step happens. In this sense, a task index could be shown to the driver of the vehicle, thus indicating the points of collection and delivery of loads as well as an estimated time of such action. A non-limiting representation of the task index is shown in FIG. 3 of the application. In one embodiment, the task index could be shown in an electronic device operable by the driver, such as his mobile phone and/or the vehicle GPS. Having described an example of a preferred embodiment, it should be understood that the scope of the present invention encompasses other possible variations, being limited only by the content of the appended claims, including the possible equivalents therein.

1. A method, comprising:
adjusting, in response to determining a selection of a freight vehicle by a model, a scheduled route associated with the freight vehicle to generate an adjusted route for the freight vehicle,
wherein the adjusted route transports the load associated with the customer order and one or more other loads associated with the scheduled route.

2. The method of claim 1,
managing 2-n loads associated with 2-n load requests,
wherein loads from one or more requests are added to freight vehicles until maximum loading capacity of the freight vehicles is achieved,
wherein a maximum number of loads from requests are matched within a freight vehicle fleet.

3. A method for load optimization in a fleet sharing among multiple freight vehicles, the method characterized by comprising the steps of:
receiving a shipping order from a first shipper, wherein the shipping order has instructions to transport a load associated to the shipping order,
continuously search for a transport opportunity involving a logistic network, wherein the first shipper is part of the logistic network,
if a transport opportunity is found, the method comprises the step of:
receiving an updated shipping order, the updated shipping order comprising instructions to transport a load associated to the updated shipping order.

4. The method according to claim 3, characterized in that the updated shipping order is associated to a second shipper.

5. The method according to claim 4, characterized in that the step of continuously search for a transport opportunity further comprises the step of:
checking if the shipping order and the updated shipping order comprise at least one data in common between each order.

6. The method according to claim 3, characterized in that the updated shipping order is an order which increases the loading capacity of the freight vehicle.

7. The method according to claim 3, characterized in that the updated shipping order may be automatically rejected or the updated shipping order may be rejected by one of the shippers of the logistic network.

8. The method according to claim 3, characterized in that, if a transport opportunity is found, the method further comprises the step of generating a displacement map for those shippers involved in the logistic network, wherein the displacement map is disposed in an screen of an electronic device.

9. The method according to claim 3, characterized in that the method further comprise the step of: classifying at least one information from at least one of the shipping order and the updated shipping order, as a confidential information.

10. The method according to claim 3, characterized in that, if a transport opportunity is found, the method further comprises the step of issue an alert to the shippers involved in the transport opportunity.

11. The method according to claim 3, characterized in that it further comprises the step of: generating an intention to interact, wherein the intention to interact is sent by a particular shipper to an additional shipper, wherein the intention to interact requests that the additional shipper to be included in the logistic network of the particular shipper.

12. System for load optimization in a fleet sharing among multiple freight vehicles, the system characterized by comprising:
means to receive a shipping order from a first shipper, wherein the shipping order has instructions to transport a load associated to the shipping order,
means to continuously search for a transport opportunity involving a logistic network, wherein the first shipper is part of the logistic network,
means to receive an updated shipping order, the updated shipping order comprising instructions to transport a load associated to the updated shipping order.

13. A cloud server, comprising:
a processor; and,
a memory coupled to the processor, the memory comprising instruction with functionality for:
receiving a shipping order from a first shipper, wherein the shipping order has instructions to transport a load associated to the shipping order,
continuously search for a transport opportunity involving a logistic network, wherein the first shipper is part of the logistic network,
if a transport opportunity is found, the method comprises the step of:
receiving an updated shipping order, the updated shipping order comprising instructions to transport a load associated to the updated shipping order.

14. A non-transitory computer readable medium storing instructions, the instructions, when executed by a computer processor, comprising functionality for:
receiving a shipping order from a first shipper, wherein the shipping order has instructions to transport a load associated to the shipping order,
continuously search for a transport opportunity involving a logistic network, wherein the first shipper is part of the logistic network,
if a transport opportunity is found, the method comprises the step of:
receiving an updated shipping order, the updated shipping order comprising instructions to transport a load associated to the updated shipping order.

15. A user device, comprising:
a processor; and
a memory coupled to the processor, the memory comprising instruction with functionality for:
transmitting a request to deliver a load to a cloud server,
obtaining information regarding an adjusted route from the cloud server.
